(19) United States
(12) Patent Application Publication
(10) Pub. No.: US 2026/0075620 A1
(43) Pub. Date: Mar. 12, 2026

(54) METHOD AND DEVICE FOR TRANSMITTING AND RECEIVING WIRELESS SIGNAL IN WIRELESS COMMUNICATION SYSTEM

(71) Applicant: LG Electronics Inc., Seoul (KR)

(72) Inventors: Sunghoon LEE, Seoul (KR); Youngdae LEE, Seoul (KR); Jaehyung KIM, Seoul (KR); Suckchel YANG, Seoul (KR); Seunggye HWANG, Seoul (KR)

(21) Appl. No.: 19/105,207

(22) PCT Filed: Sep. 26, 2023
(86) PCT No.: PCT/KR2023/014825

§ 371 Date: Feb. 20, 2025

Related U.S. Application Data
(60) Provisional application No. 63/411,571, filed on Sep. 29, 2022.

(51) Int. Cl. H04W 72/232; H04W 72/0446

(52) U.S. Cl. CPC H04W 72/232; H04W 72/0446

(57) ABSTRACT

A method for a terminal to receive a signal, according to one example of the present disclosure, comprises: receiving configuration information including information about a downlink reception cycle through upper layer signaling; receiving information about a downlink monitoring mask for adjusting the downlink reception cycle through lower layer signaling; and monitoring a downlink signal on the basis of the downlink reception cycle and the downlink monitoring mask, wherein the downlink signal may be monitored on the basis of an integer multiple of the downlink reception cycle during a first time period in which the downlink monitoring mask is not applied, and monitored on the basis of the downlink reception cycle without the integer multiple during a second time period in which the downlink monitoring mask is applied.

### TECHNICAL FIELD

The present disclosure relates to a wireless communication system, and more particularly to a method and apparatus for transmitting or receiving an uplink/downlink signal in a wireless communication system.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may be any of a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### DISCLOSURE

### Technical Problem

An object of the present disclosure is to provide a method of efficiently performing a wireless signal transmission/reception procedure and an apparatus therefor.

Other technical objects may be derived from the embodiments disclosed in the detailed description.

### Technical Solution

According to an aspect, a method of receiving a signal by a user equipment (UE) in a wireless communication system may include receiving configuration information including information about a downlink reception periodicity through higher layer signaling, receiving information about a downlink monitoring mask for adjusting the downlink reception periodicity through lower layer signaling, and monitoring a downlink signal based on the downlink reception periodicity and the downlink monitoring mask. The downlink signal may be monitored based on an integer multiple of the downlink reception periodicity during a first time period in which the downlink monitoring mask is not applied, and the downlink signal may be monitored based on the downlink reception periodicity during a second time period in which the downlink monitoring mask is applied.

The downlink signal may include a physical downlink control channel (PDCCH). The configuration information may include configuration information about a search space set for PDCCH candidates.

The information about the downlink monitoring mask may be received through downlink control information (DCI).

The downlink signal may be monitored only in some of downlink resource configurations provided to the UE during the first time period in which the downlink monitoring mask is not applied.

The downlink signal may be monitored in all of the downlink resource configurations provided to the UE during the second time period in which the downlink monitoring mask is not applied.

The first time period and the second time period may be determined based on a timer. The timer may be a discontinuous reception (DRX)-related timer.

The information about the downlink monitoring mask may activate a first downlink monitoring mask among a plurality of downlink monitoring masks configured for the UE.

The higher layer signaling may be radio resource control (RRC) signaling, and the lower layer signaling may be medium access control (MAC) signaling or physical layer (PHY) signaling.

According to another aspect, a computer-readable recording medium having recorded thereon a program for performing the above-described method of receiving a signal may be provided.

According to another aspect, a UE for performing the above-described method of receiving a signal may be provided.

According to another aspect, a device for controlling a UE performing the above-described method of receiving a signal may be provided.

According to another aspect, a method of transmitting a signal by a base station (BS) in a wireless communication system may include transmitting configuration information including information about a downlink transmission period through higher layer signaling, transmitting information about a downlink monitoring mask for adjusting the downlink transmission period through lower layer signaling, and transmitting a downlink signal based on the downlink transmission period and the downlink monitoring mask. The downlink signal may be transmitted based on an integer multiple of the downlink transmission period during a first time period in which the downlink monitoring mask is not applied, and the downlink signal may be transmitted based on the downlink transmission period during a second time period in which the downlink monitoring mask is applied.

According to another aspect, a BS for performing the above-described method of transmitting a signal may be provided.

### Advantageous Effects

According to an embodiment, a signal may be transmitted/received more accurately and more efficiently in a wireless communication system.

Other technical effects may be derived from the embodiments disclosed in the detailed description.

### BRIEF DESCRIPTION OF THE DRAWINGS

FIG. 1 illustrates physical channels used in a 3rd generation partnership project (3GPP) system as an exemplary wireless communication system, and a general signal transmission method using the same.

FIG. 2 illustrates a radio frame structure.

FIG. 3 illustrates a resource grid of a slot.

FIG. 4 illustrates exemplary mapping of physical channels in a slot.

FIG. 5 illustrates an exemplary physical downlink control channel (PDCCH) transmission and reception process.

FIG. 6 illustrates an exemplary physical downlink shared channel (PDSCH) reception and acknowledgement/negative acknowledgement (ACK/NACK) transmission process.

FIG. 7 illustrates an exemplary physical uplink shared channel (PUSCH) transmission process.

FIGS. 8 to 10 are diagrams illustrating DRX-related operations.

FIG. 11 is a diagram illustrating DL reception of a UE according to an embodiment.

FIGS. 12 and 13 are diagrams illustrating DL reception of a UE according to embodiments.

FIG. 14 is a diagram illustrating signal reception of a UE according to an embodiment.

FIG. 15 is a diagram illustrating signal transmission of a BS according to an embodiment.

FIGS. 16 to 19 illustrate an example of a communication system 1 and wireless devices applicable to the present disclosure.

### DETAILED DESCRIPTION

Embodiments of the present disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive Machine Type Communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and Ultra-Reliable and Low Latency Communication (URLLC) is being discussed. In an embodiment of the present disclosure, for simplicity, this technology will be referred to as NR (New Radio or New RAT).

For the sake of clarity, 3GPP NR is mainly described, but the technical idea of the present disclosure is not limited thereto.

For the background art relevant to the present disclosure, the definitions of terms, and abbreviations, the following documents may be incorporated by reference.
3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: NR and NG-RAN Overall Description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description
3GPP TS 23.287: Application layer support for V2X services; Functional architecture and information flows
3GPP TS 23.501: System Architecture for the 5G System
3GPP TS 23.502: Procedures for the 5G System
3GPP TS 23.503: Policy and Charging Control Framework for the 5G System; Stage 2
3GPP TS 24.501: Non-Access-Stratum (NAS) protocol for 5G System (5GS); Stage 3
3GPP TS 24.502: Access to the 3GPP 5G Core Network (5GCN) via non-3GPP access networks
3GPP TS 24.526: User Equipment (UE) policies for 5G System (5GS); Stage 3

### Terms and Abbreviations

5GC: 5G Core Network
5GS: 5G System
AP: Access Point
CID: Cell ID
E-CID: Enhanced Cell ID
PRS: Positioning Reference Signal
RRM: Radio Resource Management
TP: Transmission Point
TRP: Transmission and Reception Point
UE: User Equipment
SSB: Synchronization Signal Block
SFN: System Frame Number
SS: Search Space
CSS: Common Search Space
USS: UE-specific Search Space
PDCCH: Physical Downlink Control Channel
PDSCH: Physical Downlink Shared Channel;
PUCCH: Physical Uplink Control Channel;
PUSCH: Physical Uplink Shared Channel;
DCI: Downlink Control Information
UCI: Uplink Control Information
SI: System Information
SIB: System Information Block
MIB: Master Information Block
RRC: Radio Resource Control
DRX: Discontinuous Reception
RNTI: Radio Network Temporary Identifier
CSI: Channel state information
PCell: Primary Cell
SCell: Secondary Cell
PSCell: Primary SCG (Secondary Cell Group) Cell
CA: Carrier Aggregation
WUS: Wake up Signal
PO: Paging Occasion
PEI: Paging Early Indication
PEI-O: PEI Occasion
NES: Network Energy Saving
RO: RACH Occasion
RAR: Random Access Response
SDT: Small Data Transmission

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

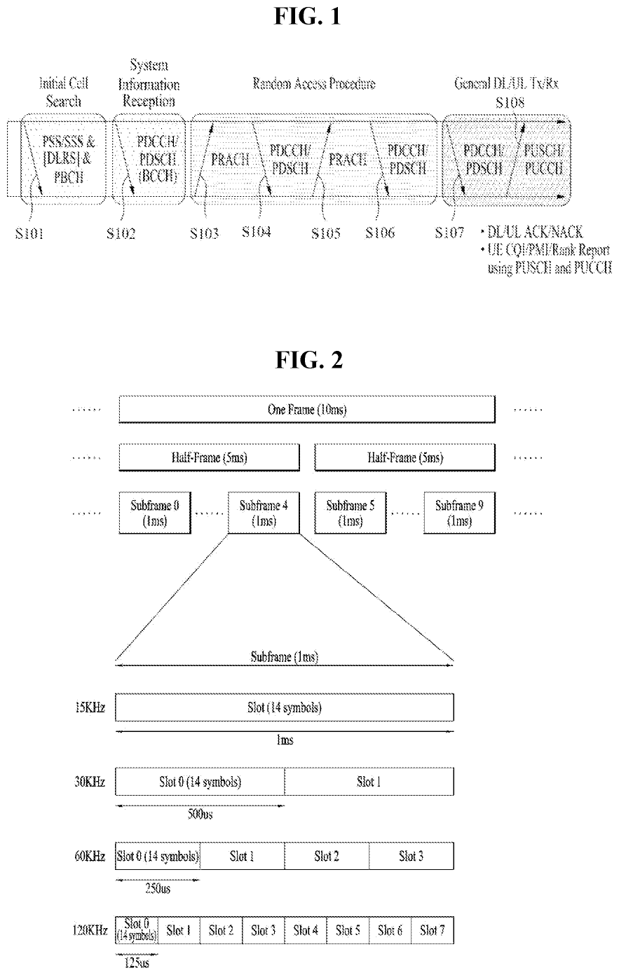

FIG. 1 illustrates physical channels used in a 3GPP NR system and a general signal transmission method using the same.

When a UE is powered on again from a power-off state or enters a new cell, the UE performs an initial cell search procedure, such as establishment of synchronization with a BS, in step S101. To this end, the UE receives a synchronization signal block (SSB) from the BS. The SSB includes a primary synchronization signal (PSS), a secondary synchronization signal (SSS), and a physical broadcast channel (PBCH). The UE establishes synchronization with the BS based on the PSS/SSS and acquires information such as a cell identity (ID). The UE may acquire broadcast information in a cell based on the PBCH. The UE may receive a DL reference signal (RS) in an initial cell search procedure to monitor a DL channel status.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 Orthogonal Frequency Division Multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| | | | |
|---|---|---|---|
| SCS (15*2^{u}) | N^{slot}_{symb} | N^{frame, u}ₛₗₒₜ | N^{subframe, u}ₛₗₒₜ |

| | | | | |
|---|---|---|---|---|
| 15 KHz | (u = 0) | 14 | 10 | 1 |
| 30 KHz | (u = 1) | 14 | 20 | 2 |
| 60 KHz | (u = 2) | 14 | 40 | 4 |
| 120 KHz | (u = 3) | 14 | 80 | 8 |
| 240 KHz | (u = 4) | 14 | 160 | 16 |

Table 2 illustrates that the number of symbols per slot, the number of slots per frame, and the number of slots per subframe vary according to the SCS when the extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The structure of the frame is merely an example. The number of subframes, the number of slots, and the number of symbols in a frame may vary.

In the NR system, OFDM numerology (e.g., SCS) may be configured differently for a plurality of cells aggregated for one UE. Accordingly, the (absolute time) duration of a time resource (e.g., an SF, a slot or a TTI) (for simplicity, referred to as a time unit (TU)) consisting of the same number of symbols may be configured differently among the aggregated cells. Here, the symbols may include an OFDM symbol (or a CP-OFDM symbol) and an SC-FDMA symbol (or a discrete Fourier transform-spread-OFDM (DFT-s-OFDM) symbol).

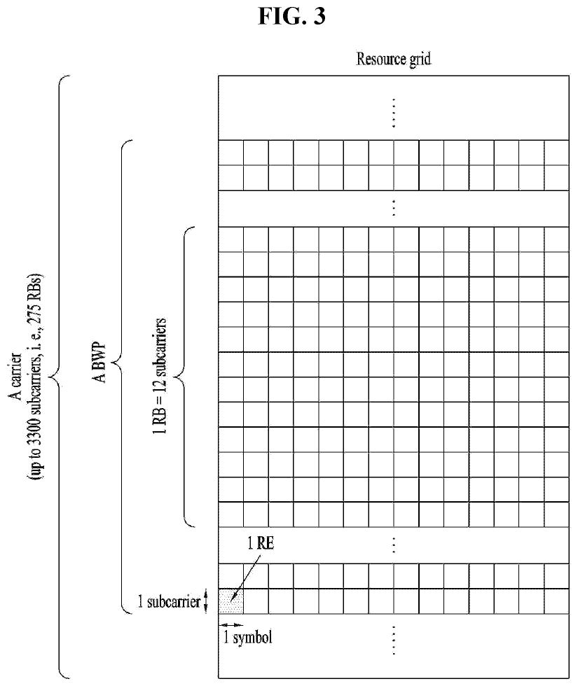

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

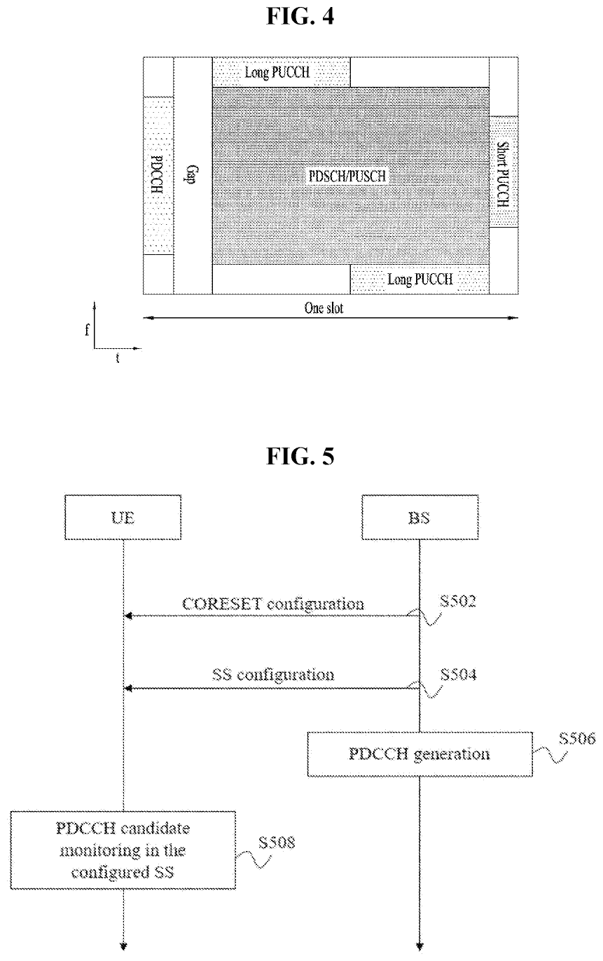

FIG. 4 illustrates an example of mapping physical channels in a slot. In an NR system, a frame is characterized by a self-contained structure in which all of a DL control channel, DL or UL data, and a UL channel may be included in one slot. For example, the first N symbols of a slot may be used to carry a DL channel (e.g., PDCCH) (hereinafter, referred to as a DL control region), and the last M symbols of the slot may be used to carry a UL channel (e.g., PUCCH) (hereinafter, referred to as a UL control region). Each of N and M is an integer equal to or larger than 0. A resource area (hereinafter, referred to as a data region) between the DL control region and the UL control region may be used to transmit DL data (e.g., PDSCH) or UL data (e.g., PUSCH). A guard period (GP) provides a time gap for switching from a transmission mode to a reception mode or from the reception mode to the transmission mode. Some symbols at a DL-to-UL switching time in a subframe may be configured as a GP.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g., a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

FIG. 5 illustrates an exemplary PDCCH transmission/reception process.

Referring to FIG. 5, a BS may transmit a control resource set (CORESET) configuration to a UE (S502). A CORESET is defined as a resource element group (REG) set having a given numerology (e.g., a subcarrier spacing (SCS), a cyclic prefix (CP) length, and so on). An REG is defined as one OFDM symbol by one (physical) resource block (P) RB. A plurality of CORESETs for one UE may overlap with each other in the time/frequency domain. A CORESET may be configured by system information (e.g., a master information block (MIB)) or higher-layer signaling (e.g., radio resource control (RRC) signaling). For example, configuration information about a specific common CORESET (e.g., CORESET #0) may be transmitted in the MIB. For example, a PDSCH carrying system information block 1 (SIB1) may be scheduled by a specific PDCCH, and CORESET #0 may be used to transmit the specific PDCCH. Further, configuration information about CORESET #N (e.g., N>0) may be transmitted by RRC signaling (e.g., cell-common RRC signaling, UE-specific RRC signaling, or the like). For example, the UE-specific RRC signaling carrying CORESET configuration information may include, but not limited to, various types of signaling such as an RRC setup message, an RRC reconfiguration message, and/or BWP configuration information. Specifically, a CORESET configuration may include the following information/fields.
controlResourceSetId: Indicates the ID of a CORESET.
frequency DomainResources: Indicates the frequency-domain resources of the CORESET. The resources are indicated by a bitmap in which each bit corresponds to an RB group (=6 (consecutive) RBs). For example, the most significant bit (MSB) of the bitmap corresponds to a first RB group in a BWP. An RB group corresponding to a bit having a bit value of 1 is allocated as frequency-domain resources of the CORESET.
duration: Indicates the time-domain resources of the CORESET. It indicates the number of consecutive OFDM symbols included in the CORESET. The duration has a value between 1 and 3.
cce-REG-MappingType: Indicates a control channel element (CCE)-to-REG mapping type. An interleaved type and a non-interleaved type are supported.
interleaverSize: Indicates an interleaver size.
pdcch-DMRS-ScramblingID: Indicates a value used for PDCCH DMRS initialization. When pdcch-DMRS-ScramblingID is not included, the physical cell ID of a serving cell is used.
precoderGranularity: Indicates a precoder granularity in the frequency domain.
reg-BundleSize: Indicates an REG bundle size.
tci-PresentInDCI: Indicates whether a transmission configuration index (TCI) field is included in DL-related DCI.
tci-StatesPDCCH-ToAddList: Indicates a subset of TCI states configured in pdcch-Config, used for providing quasi-co-location (QCL) relationships between DL RS(s) in an RS set (TCI-State) and PDCCH DMRS ports.

Further, the BS may transmit a PDCCH search space (SS) configuration to the UE (S504). The PDCCH SS configuration may be transmitted by higher-layer signaling (e.g., RRC signaling). For example, the RRC signaling may include, but not limited to, various types of signaling such as an RRC setup message, an RRC reconfiguration message, and/or BWP configuration information. While a CORESET configuration and a PDCCH SS configuration are shown as separately signaled in FIG. 5, for convenience of description, the present disclosure is not limited thereto. For example, the CORESET configuration and the PDCCH SS configuration may be transmitted in one message (e.g., by one RRC signaling) or separately in different messages.

The PDCCH SS configuration may include information about the configuration of a PDCCH SS set. The PDCCH SS set may be defined as a set of PDCCH candidates monitored (e.g., blind-detected) by the UE. One or more SS sets may be configured for the UE. Each SS set may be a UE-specific search space (USS) set or a common search space (CSS) set. For convenience, PDCCH SS set may be referred to as “SS” or “PDCCH SS”.

A PDCCH SS set includes PDCCH candidates. A PDCCH candidate is CCE(s) that the UE monitors to receive/detect a PDCCH. The monitoring includes blind decoding (BD) of PDCCH candidates. One PDCCH (candidate) includes 1, 2, 4, 8, or 16 CCEs according to an aggregation level (AL). One CCE includes 6 REGs. Each CORESET configuration is associated with one or more SSs, and each SS is associated with one CORESET configuration. One SS is defined based on one SS configuration, and the SS configuration may include the following information/fields.
searchSpaceId: Indicates the ID of an SS.
controlResourceSetId: Indicates a CORESET associated with the SS.
monitoringSlotPeriodicity AndOffset: Indicates a periodicity (in slots) and offset (in slots) for PDCCH monitoring.
monitoringSymbolsWithinSlot: Indicates the first OFDM symbol(s) for PDCCH monitoring in a slot configured with PDCCH monitoring. The first OFDM symbol(s) for PDCCH monitoring is indicated by a bitmap with each bit corresponding to an OFDM symbol in the slot. The MSB of the bitmap corresponds to the first OFDM symbol of the slot. OFDM symbol(s) corresponding to bit(s) set to 1 corresponds to the first symbol(s) of a CORESET in the slot.
nrofCandidates: Indicates the number of PDCCH candidates (one of values 0, 1, 2, 3, 4, 5, 6, and 8) for each AL where AL={1, 2, 4, 8, 16}.
searchSpaceType: Indicates CSS or USS as well as a DCI format used in the corresponding SS type.

Subsequently, the BS may generate a PDCCH and transmit the PDCCH to the UE (S506), and the UE may monitor PDCCH candidates in one or more SSs to receive/detect the PDCCH (S508). An occasion (e.g., time/frequency resources) in which the UE is to monitor PDCCH candidates is defined as a PDCCH (monitoring) occasion. One or more PDCCH (monitoring) occasions may be configured in a slot.

Table 3 shows the characteristics of each SS.

TABLE 3

| | Search | | |
|---|---|---|---|
| Type | Space | RNTI | Use Case |
| Type0-PDCCH | Common | SI-RNTI on a primary cell | SIB Decoding |
| Type0A-PDCCH | Common | SI-RNTI on a primary cell | SIB Decoding |
| Type1-PDCCH | Common | RA-RNTI or TC-RNTI on a | Msg2, Msg4 |
| | | primary cell | decoding in |
| | | | RACH |
| Type2-PDCCH | Common | P-RNTI on a primary cell | Paging Decoding |
| Type3-PDCCH | Common | INT-RNTI, SFI-RNTI, TPC-PUSCH-RNTI, | |
| | | TPC-PUCCH-RNTI, TPC-SRS-RNTI, C-RNTI, | |
| | | MCS-C-RNTI, or CS-RNTI(s) | |
| | UE Specific | C-RNTI, or MCS-C-RNTI, or CS-RNTI(s) | User specific |
| | | | PDSCH decoding |

Table 4 shows DCI formats transmitted on the PDCCH.

TABLE 4

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and PUSCH |
| 2_3 | Transmission of a group of TPC commands for |
| | SRS transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2 0 and/or DCI format 2_1 may be delivered to a corresponding group of UEs on a group common PDCCH which is a PDCCH directed to a group of UEs.

DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

A CCE-to-REG mapping type is configured as one of an interleaved CCE-to-REG type and a non-interleaved CCE-to-REG type.
Non-interleaved CCE-to-REG mapping (or localized CCE-to-REG mapping) (FIG. 5): 6 REGs for a given CCE are grouped into one REG bundle, and all of the REGs for the given CCE are contiguous. One REG bundle corresponds to one CCE.
Interleaved CCE-to-REG mapping (or distributed CCE-to-REG mapping): 2, 3 or 6 REGs for a given CCE are grouped into one REG bundle, and the REG bundle is interleaved within a CORESET. In a CORESET including one or two OFDM symbols, an REG bundle includes 2 or 6 REGs, and in a CORESET including three OFDM symbols, an REG bundle includes 3 or 6 REGs. An REG bundle size is set on a CORESET basis.

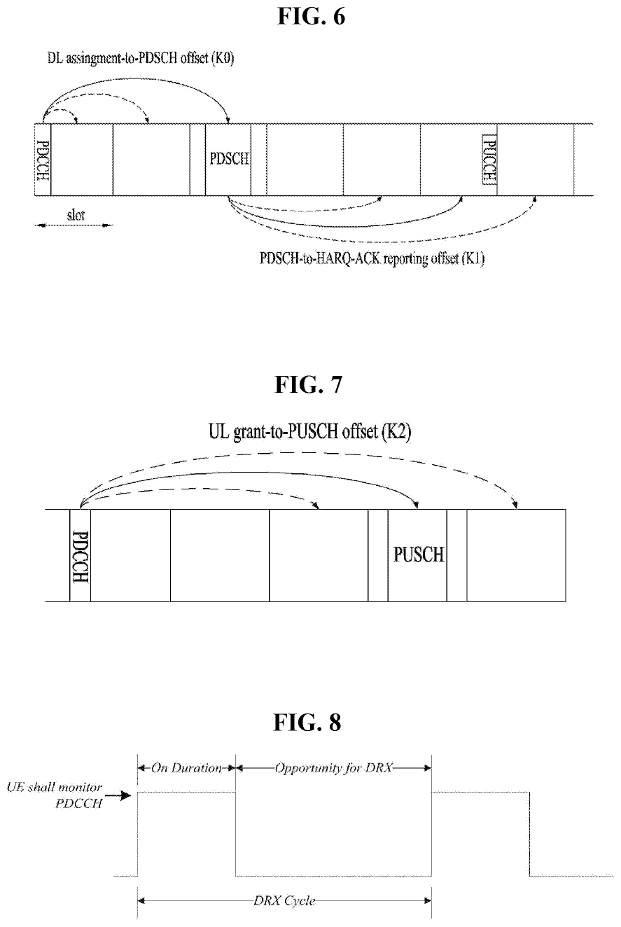

FIG. 6 illustrates an exemplary PDSCH reception and ACK/NACK transmission process. Referring to FIG. 6, the UE may detect a PDCCH in slot #n. The PDCCH includes DL scheduling information (e.g., DCI format 1_0 or DCI format 1_1) and indicates a DL assignment-to-PDSCH offset, K0 and a PDSCH-HARQ-ACK reporting offset, K1. For example, DCI format 1_0 or DCI format 1_1 may include the following information.
Frequency domain resource assignment: Indicates an RB set allocated to a PDSCH.
Time domain resource assignment: Indicates K0 (e.g., slot offset), the starting position (e.g., OFDM symbol index) of the PDSCH in slot #n+K0, and the duration (e.g., the number of OFDM symbols) of the PDSCH.
PDSCH-to-HARQ_feedback timing indicator: Indicates K1.
HARQ process number (4 bits): Indicates the HARQ process ID of data (e.g., a PDSCH or TB).
PUCCH resource indicator (PRI): Indicates a PUCCH resource to be used for UCI transmission among a plurality of PUCCH resources in a PUCCH resource set.

After receiving a PDSCH in slot #(n+K0) according to the scheduling information of slot #n, the UE may transmit UCI on a PUCCH in slot #(n+K1). The UCI may include an HARQ-ACK response to the PDSCH. FIG. 5 is based on the assumption that the SCS of the PDSCH is equal to the SCS of the PUCCH, and slot #n1=slot #(n+K0), for convenience, which should not be construed as limiting the present disclosure. When the SCSs are different, K1 may be indicated/interpreted based on the SCS of the PUCCH.

In the case where the PDSCH is configured to carry one TB at maximum, the HARQ-ACK response may be configured in one bit. In the case where the PDSCH is configured to carry up to two TBs, the HARQ-ACK response may be configured in 2 bits if spatial bundling is not configured and in 1 bit if spatial bundling is configured. When slot #(n+K1) is designated as an HARQ-ACK transmission timing for a plurality of PDSCHs, UCI transmitted in slot #(n+K1) includes HARQ-ACK responses to the plurality of PDSCHs.

Whether the UE should perform spatial bundling for an HARQ-ACK response may be configured for each cell group (e.g., by RRC/higher layer signaling). For example, spatial bundling may be configured for each individual HARQ-ACK response transmitted on the PUCCH and/or HARQ-ACK response transmitted on the PUSCH.

When up to two (or two or more) TBs (or codewords) may be received at one time (or schedulable by one DCI) in a corresponding serving cell (e.g., when a higher layer parameter maxNrofCodeWordsScheduledByDCI indicates 2 TBs), spatial bundling may be supported. More than four layers may be used for a 2-TB transmission, and up to four layers may be used for a 1-TB transmission. As a result, when spatial bundling is configured for a corresponding cell group, spatial bundling may be performed for a serving cell in which more than four layers may be scheduled among serving cells of the cell group. A UE which wants to transmit an HARQ-ACK response through spatial bundling may generate an HARQ-ACK response by performing a (bit-wise) logical AND operation on A/N bits for a plurality of TBs.

For example, on the assumption that the UE receives DCI scheduling two TBs and receives two TBs on a PDSCH based on the DCI, a UE that performs spatial bundling may generate a single A/N bit by a logical AND operation between a first A/N bit for a first TB and a second A/N bit for a second TB. As a result, when both the first TB and the second TB are ACKs, the UE reports an ACK bit value to a BS, and when at least one of the TBs is a NACK, the UE reports a NACK bit value to the BS.

For example, when only one TB is actually scheduled in a serving cell configured for reception of two TBs, the UE may generate a single A/N bit by performing a logical AND operation on an A/N bit for the one TB and a bit value of 1. As a result, the UE reports the A/N bit for the one TB to the BS.

There are plurality of parallel DL HARQ processes for DL transmissions at the BS/UE. The plurality of parallel HARQ processes enable continuous DL transmissions, while the BS is waiting for an HARQ feedback indicating successful or failed reception of a previous DL transmission. Each HARQ process is associated with an HARQ buffer in the medium access control (MAC) layer. Each DL HARQ process manages state variables such as the number of MAC physical data unit (PDU) transmissions, an HARQ feedback for a MAC PDU in a buffer, and a current redundancy version. Each HARQ process is identified by an HARQ process ID.

FIG. 7 illustrates an exemplary PUSCH transmission procedure. Referring to FIG. 7, the UE may detect a PDCCH in slot #n. The PDCCH includes DL scheduling information (e.g., DCI format 1_0 or 1_1). DCI format 1_0 or 1_1 may include the following information.
Frequency domain resource assignment: Indicates an RB set assigned to the PUSCH.
Time domain resource assignment: Indicates a slot offset K2 and the starting position (e.g., OFDM symbol index) and duration (e.g., the number of OFDM symbols) of the PUSCH in a slot. The starting symbol and length of the PUSCH may be indicated by a start and length indicator value (SLIV), or separately.

The UE may then transmit a PUSCH in slot #(n+K2) according to the scheduling information in slot #n. The PUSCH includes a UL-SCH TB.

### DRX (Discontinuous Reception)

### (1) RRC_CONNECTED DRX

FIG. 8 is a diagram illustrating a DRX operation of a UE.

The UE may perform a DRX operation in the afore-described/proposed procedures and/or methods. A UE configured with DRX may reduce power consumption by receiving a DL signal discontinuously. DRX may be performed in an RRC_IDLE state, an RRC_INACTIVE state, and an RRC_CONNECTED state. The UE performs DRX to receive a paging signal discontinuously in the RRC_IDLE state and the RRC INACTIVE state. DRX in the RRC CONNECTED state (RRC_CONNECTED DRX) will be described below.

Referring to FIG. 8, a DRX cycle includes an On Duration and an Opportunity for DRX. The DRX cycle defines a time interval between periodic repetitions of the On Duration. The On Duration is a time period during which the UE monitors a PDCCH. When the UE is configured with DRX, the UE performs PDCCH monitoring during the On Duration. When the UE successfully detects a PDCCH during the PDCCH monitoring, the UE starts an inactivity timer and is kept awake. On the contrary, when the UE fails in detecting any PDCCH during the PDCCH monitoring, the UE transitions to a sleep state after the On Duration. Accordingly, when DRX is configured, PDCCH monitoring/reception may be performed discontinuously in the time domain in the afore-described/proposed procedures and/or methods. For example, when DRX is configured, PDCCH reception occasions (e.g., slots with PDCCH SSs) may be configured discontinuously according to a DRX configuration in an embodiment of the present disclosure. On the contrary, when DRX is not configured, PDCCH monitoring/reception may be performed continuously in the time domain. For example, when DRX is not configured, PDCCH reception occasions (e.g., slots with PDCCH SSs) may be configured continuously in an embodiment of the present disclosure. Irrespective of whether DRX is configured, PDCCH monitoring may be restricted during a time period configured as a measurement gap.

Table 5 describes a DRX operation of a UE (in the RRC_CONNECTED state). Referring to Table 5, DRX configuration information is received by higher-layer signaling (e.g., RRC signaling), and DRX ON/OFF is controlled by a DRX command from the MAC layer. Once DRX is configured, the UE may perform PDCCH monitoring discontinuously in performing the afore-described/proposed procedures and/or methods.

TABLE 5

| | Type of signals | UE procedure |
|---|---|---|
| 1st step | RRC signalling | Receive DRX configuration |
| | (MAC-CellGroupConfig) | information |
| 2nd Step | MAC CE ((Long) | Receive DRX command |
| | DRX command MAC CE) | |
| 3rd Step | — | Monitor a PDCCH during an on- |
| | | duration of a DRX cycle |

MAC-CellGroupConfig includes configuration information required to configure MAC parameters for a cell group. MAC-CellGroupConfig may also include DRX configuration information. For example, MAC-CellGroupConfig may include the following information in defining DRX.-Value of drx-OnDurationTimer: defines the duration of the starting period of the DRX cycle.

Value of drx-Inactivity Timer: defines the duration of a time period during which the UE is awake after a PDCCH occasion in which a PDCCH indicating initial UL or DL data has been detected

Value of drx-HARQ-RTT-TimerDL: defines the duration of a maximum time period until a DL retransmission is received after reception of a DL initial transmission.

Value of drx-HARQ-RTT-TimerDL: defines the duration of a maximum time period until a grant for a UL retransmission is received after reception of a grant for a UL initial transmission.

drx-LongCycleStartOffset: defines the duration and starting time of a DRX cycle.

drx-ShortCycle (optional): defines the duration of a short DRX cycle.

When any of drx-OnDurationTimer, drx-Inactivity Timer, drx-HARQ-RTT-TimerDL, and drx-HARQ-RTT-TimerDL is running, the UE performs PDCCH monitoring in each PDCCH occasion, staying in the awake state.

### (2) RRC_IDLE DRX

In the RRC_IDLE and RRC_INACTIVE states, DRX is used to receive a paging signal discontinuously. For simplicity, DRX performed in the RRC_IDLE (or RRC_INACTIVE) state will be referred to as RRC_IDLE DRX.

Therefore, if DRX is configured, PDCCH monitoring/reception may be performed discontinuously in the time domain in performing the above-described/proposed procedures and/or methods are performed.

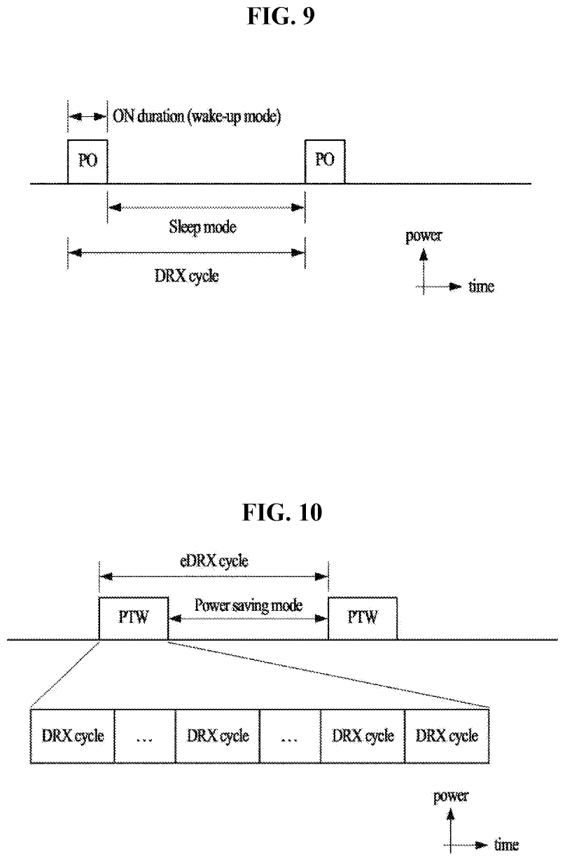

FIG. 9 illustrates an exemplary DRX cycle for paging.

Referring to FIG. 9, DRX may be configured for discontinuous reception of a paging signal. The UE may receive DRX configuration information from the BS by higher-layer (e.g., RRC) signaling. The DRX configuration information may include configuration information related to a DRX cycle, a DRX offset, a DRX timer, and the like. The UE repeats an On duration and a Sleep duration according to the DRX cycle. The UE may operate in a wakeup mode during the On duration and in a sleep mode during the Sleep duration.

In the wakeup mode, the UE may monitor a PO to receive a paging message. A PO means a time resource/interval (e.g., subframe or slot) in which the UE expects to receive a paging message. PO monitoring includes monitoring a PDCCH (MPDCCH or NPDCCH) scrambled with a P-RNTI (hereinafter, referred to as a paging PDCCH) on a PO. The paging message may be included in the paging PDCCH or in a PDSCH scheduled by the paging PDCCH. One or more POs may be included in a paging frame (PF), and the PF may be periodically configured based on a UE ID. A PF may correspond to one radio frame, and the UE ID may be determined based on the International Mobile Subscriber Identity (IMSI) of the UE. When DRX is configured, the UE monitors only one PO per DRX cycle. When the UE receives a paging message indicating a change of its ID and/or system information on a PO, the UE may perform an RACH procedure to initialize (or reconfigure) a connection with the BS, or receive (or obtain) new system information from the BS. Therefore, PO monitoring may be performed discontinuously in the time domain to perform an RACH procedure for connection to the BS or to receive (or obtain) new system information from the BS in the above-described procedures and/or methods.

FIG. 10 illustrates an extended DRX (eDRX) cycle.

According to the DRX cycle configuration, the maximum cycle duration may be limited to 2.56 seconds. However, in the case of a UE that intermittently performs data transmission/reception, such as an MTC UE or an NB-IoT UE, unnecessary power consumption may occur during the DRX cycle. In order to further reduce the power consumption of the UE, a method of significantly extending the DRX cycle based on a power saving mode (PSM) and a paging time window or paging transmission window (PTW) has been introduced. The extended DRX cycle is simply referred to as an eDRX cycle. Specifically, paging hyper-frames (PHs) are periodically configured based on the UE ID, and a PTW is defined in the PHs. The UE may perform a DRX cycle in the PTW duration to switch to the wakeup mode on the PO thereof to monitor the paging signal. One or more DRX cycles (e.g., wake-up mode and sleep mode) of FIG. 9 may be included in the PTW duration. The number of DRX cycles in the PTW duration may be set by the BS through a higher layer (e.g., RRC) signal.

### Signal Transmission/Reception Related to Energy Saving

Energy saving of BSs/networks as well as energy saving of UEs is under discussion. As energy saving of BSs/networks may contribute to building eco-friendly networks by reducing carbon emissions and reducing operational expenditure (OPEX) of telecommunications operators, it is being studied in the network energy savings (NES) of 3GPP NR release 18. Specifically, how to achieve a more efficient operation dynamically and/or semi-statically and how to achieve more detailed adaptation of transmission/reception in NES techniques in the time, frequency, space, and power domains.

In one of NES methods, a BS may at least partially suspend/deactivate DL signal transmission and/or UL signal reception in a specific time period/frequency band.

A common understanding between a UE and a BS is required regarding an NES operation performed by the BS. For example, the absence of an accurate understanding between the UE and the BS regarding application of the NES operation and transmittable/receivable signals may cause malfunctions and power waste.

The BS may configure cell discontinuous transmission (DTX) for the UE to suspend/deactivate DL signal transmission in a specific time period/frequency band. The BS may configure cell discontinuous reception (DRX) for the UE to suspend/deactivate UL signal transmission in a specific time period/frequency band. A cell DTX configuration/cell DRX configuration (e.g., higher layer signaling) may include a configuration for a cell inactive period for NES. Further, activation/deactivation of the cell DTX configuration/cell DRX configuration may be dynamically indicated to the UE through a control channel (e.g., DCI-based indication) or a data channel (e.g., PDSCH or PUSCH).

A target UL/DL signal for energy saving may be completely turned off or transmitted and received in a relatively low frequency/density and/or power during an inactive period.

Although the following description is given on the assumption that a target DL signal for which a UE determines whether to perform monitoring (a reception procedure) in relation to energy saving is PDCCH, the target signal is not limited to the PDCCH, and may include at least one of CSI-RS, PRS, PDSCH (Dynamic grant and/or SPS PDSCH), and/or DMRS for PDCCH/PDSCH.

Further, energy saving may mean at least one of energy saving of a UE or energy saving of a BS depending on the context in the following description.

The proposals for energy saving described below may also be used for an XR service. To support XR services (FS_NR_XR_enh), various scenarios and candidate technologies have recently been discussed in the Rel-18 NR standard. The XR services generally require high data rates and low latency, and various techniques for power saving are considered because UEs are expected to consume much power. A traffic model and requirements of the XR services are defined in TR38.838, a technical report of the Rel-17 XR study. The XR services generally require 60 fps (frames per second), and sometimes 120 fps. A frame in the XR traffic model may be understood as the same as a packet received in a communication environment. To process such a periodic transmission and achieve power saving, a DRX operation and a monitoring adaptation operation may be considered for a UE supporting the XR services.

The UE DRX operation described before with reference to FIGS. 8 to 10 may be configured/performed in conjunction with NES. A DRX operation of a UE will be described briefly. DRX used to reduce unnecessary power consumption of a UE in NR has the following characteristics. A DRX structure for a UE in the RRC_IDLE state and a DRX structure for a UE in the RRC_CONNECTED state are defined separately, and both DRX structures are designed such that a period in which a UE may expect to receive a DL signal is defined to occur periodically and unnecessary power consumption is reduced in other periods. Particularly in C-DRX (i.e. DRX applied to a UE in the RRC_CONNECTED state), the start position of an On-duration occurs periodically based on the Rel-16 standard of NR, and the length of a configurable cycle (i.e. DRX cycle) may be determined by a higher layer parameter provided to a UE by a BS.

The UE may be configured with up to 10 SS sets in each BWP and monitor PDCCH candidates included in the SS sets. Since the UE should perform blind decoding (BD) for a PDCCH whose reception time and DCI format are not known, PDCCH monitoring accounts for a large portion of power consumption. In order to reduce BD attempts of the UE for the purpose of power saving, a monitoring adaptation operation and a method of adjusting (generally reducing) the number of monitoring operations to be performed by the UE may be proposed.

For example, the proposals described below may be used to reduce the number of PDCCH BD attempts of the UE in order to achieve power saving while smoothly supporting an XR service.

For example, a configuration and indication and a UE operation for reducing the number of DL signal reception attempts (e.g., PDCCH BD attempts) of the UE are proposed.

For example, a method is proposed in which a UE attempts DL signal detection (e.g., PDCCH monitoring) a small number of times, and upon receipt of a specific indication, increases the number of monitorings. In this case, the UE may expect a power saving effect by sparse PDCCH monitoring until receiving the specific indication, and smoothly receive heavy traffic by additionally increasing the number of monitorings through the specific indication. In addition, a method of reducing the number of BDs through DCI linkage is proposed. In a multiple DCI-linked configuration, upon receipt of one DCI, the UE may expect to receive a linked DCI, and receive it by fewer BDs.

An XR service exemplified below is an applicable example, and thus the proposed methods are not limited to the XR service. For example, the proposed methods may be extended to all signals that the UE receives with a specific periodicity. The proposed methods are applicable to all types of transmission and reception methods that the BS and the UE expect. While the following description is given in the context of an NR system by way of example, it is apparent that the proposed methods are applicable to all wireless communication transmission and reception structures and services.

In the following description, distinction is made between methods or options to clarify the description, and each of the methods or options should not be interpreted as implemented as an independent invention. For example, although the methods/options described below may be implemented individually, at least some of them may be implemented in combination, unless they contradict each other.

### [Proposal 1] Method of Adjusting the Number of PDCCH Monitorings by Additionally Allocating SS Set (or CORESET)

A small number of PDCCH monitorings may configured for the UE by default, and an SS set (or CORESET) to be monitored by the UE may be dynamically additionally allocated by an indication. That is, the UE may be maintained in a low power consumption state by performing PDCCH monitoring a small number of times before receiving a specific indication, and an SS set (or CORESET) may be additionally allocated to the UE by the specific indication (e.g., DCI or a MAC CE), such that the UE performs PDCCH monitoring more times from a specific slot. While the following methods are described in the context of an SS set, an SS set may be replaced with a CORESET.

[Proposal 1-1] DL Signal Detection Mask on/Off

For example, it is assumed that a DL signal detection mask is a PDCCH monitoring mask.
Default monitoring operation in BWP

By default, the UE is configured with dense monitoring occasions of SS sets in a BWP for traffic reception. This may be a method of reducing the period of SS sets that may be configured in a BWP. In addition, a default monitoring operation of the UE is performed in the BWP every nth period, not every period of each SS set, so that the number of BDs is set to be smaller than in a general case.

Alternatively, in order to reduce the number of default monitorings in the BWP, only a specific SS set may be monitored, not all of configured SS sets. That is, although the UE may be configured with up to 10 SS sets in the BW, it may only monitor some (not all) SS sets preconfigured through higher layer signaling, not all of the SS sets configured in the BWP. These SS sets may be SS sets which have a relatively large period and thus sparsely configured monitoring occasions.
DL signal monitoring mask (e.g., PDCCH monitoring mask)

A DL signal monitoring mask may be configured to receive all DL signal configurations configured for a BWP within a specific period. For example, a PDCCH monitoring mask may be configured to receive all SS sets configured for a BWP within a specific period. This may be in the form of a window. Within the mask, default DL signal detection (PDCCH monitoring) which has been densely configured is performed in the BWP. For example, the UE monitors relatively sparse preconfigured SS sets in an unmasked period, and monitors densely configured default SS sets in a masked period. In other words, the number of PDCCH monitorings may be adjusted to be large/small by PDCCH monitoring mask on/off.

From the perspective of PDCCH monitoring of the UE, although MOs are located densely in SS sets configured for a BWP to increase the number of MOs by default, this may be interpreted that the MOs of some SS sets are covered by a default configuration, and the UE does not monitor in the corresponding occasions. The UE may also receive information indicating to the UE to perform PDCCH monitoring in MOs that are located but covered during a specific configured/indicated period (mask).
Configuration and indication of DL signal monitoring mask (e.g., PDCCH monitoring mask)

The size and offset of a DL signal (PDCCH) monitoring mask may be preconfigured, for example, in units of slots or symbols. It may be based on higher layer signaling of a BWP configuration, and one of several candidates may be configured/indicated by the BS.

For example, the UE may receive information indicating DL signal (PDCCH) monitoring mask on by DCI. For this purpose, a field indicating the corresponding indication may be included in the DCI. The corresponding field may be configured in various forms. For example, on/off may be indicated by 1 bit. Alternatively, one of preconfigured mask positions (a start offset from a reception time of the DCI) may be indicated by n bits. Alternatively, the corresponding field may include an indication of a mask size. That is, the field may indicate the size and/or offset of the DL signal (PDCCH) monitoring mask.

### [Proposal 1-2] Adjustment of the Number of Monitorings by Explicit/Implicit Indication

A default number of DL signal (PDCCH) detections/monitorings in a BWP may be set to be small for the UE, and the UE may be instructed to increase the number of DL signal (PDCCH) detections/monitorings by an indication. For example, MOs of SS sets may be configured in the BWP in a general manner, and PDCCH monitoring may be performed every nth period by default, not every period.

Upon receipt of arbitrary or specific DCI, the UE operates to detect/monitor a DL signal (PDCCH) in all supported/MOs of configured DL signal configurations (e.g., SS sets). The reception of the arbitrary or specific DCI may not be to check information in the DCI. In other words, the PDCCH monitoring operation may be changed implicitly by detecting the DCI. The specific DCI may be scrambled with a specific RNTI (e.g. C-RNTI) or may be a specific DCI format.

Alternatively, it may be an operation linked to a DRX timer. For example, when drx-inactivity Timer starts with a new transmission, the UE may change the DL signal (PDCCH) detection/monitoring operation. In this case, as drx-inactivity Timer starts, the UE may perform DL signal (PDCCH) detection/monitoring a small number of times, expecting the power saving effect, and upon receipt of a new transmission in DRX, may switch to a larger number of DL signal (PDCCH) detections/monitorings and perform an operation with increased power consumption for traffic reception.

As in Proposal 1-1, the UE may receive an indication for explicitly changing the DL signal (PDCCH) detection/monitoring operation through a specific field in DCI.

The UE may change from an operation of performing a large number of DL signal (PDCCH) detection/monitoring operations to an operation of performing a small number of DL signal (PDCCH) detection/monitoring operations. The corresponding operation may be explicitly indicated by DCI. In this case, the field indicating this may be set in the form of toggling along with the opposing operation. In other words, when a large number of DL signal (PDCCH) detection/monitoring operations are performed currently, the field may indicate switching to a small number of DL signal (PDCCH) detection/monitoring operations, and when a small number of DL signal (PDCCH) detection/monitoring operations are performed currently, the field may indicate switching to a large number of DL signal (PDCCH) detection/monitoring operations.

Alternatively, it may be an operation linked to a DRX timer. For example, when drx-retransmission TimerDL (or drx-retransmissionTimerUL) starts, it may be switched to the operation of performing a small number of DL signal (PDCCH) detection/monitoring operations. This may be done for the purpose of achieving the power saving effect by reducing the number of DL signal (PDCCH) detections/monitorings in the case of HARQ retransmission.

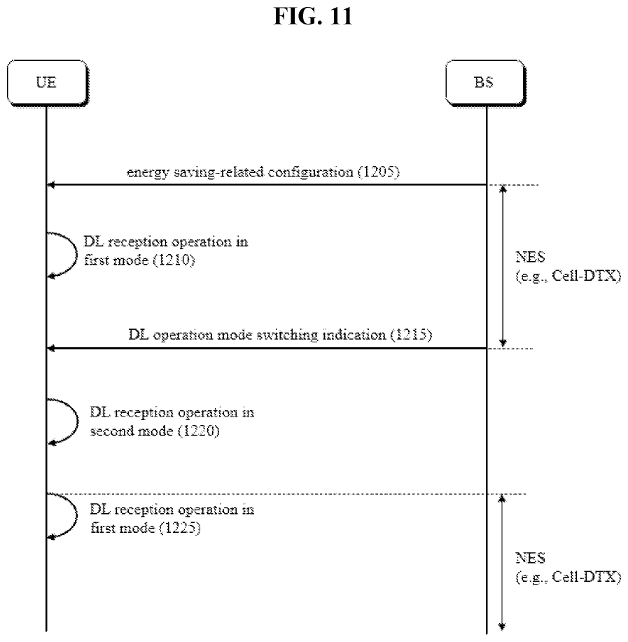

FIG. 11 illustrates an example of DL reception of a UE. FIG. 11 may be understood as an example of DL signal reception based on Proposal 1.

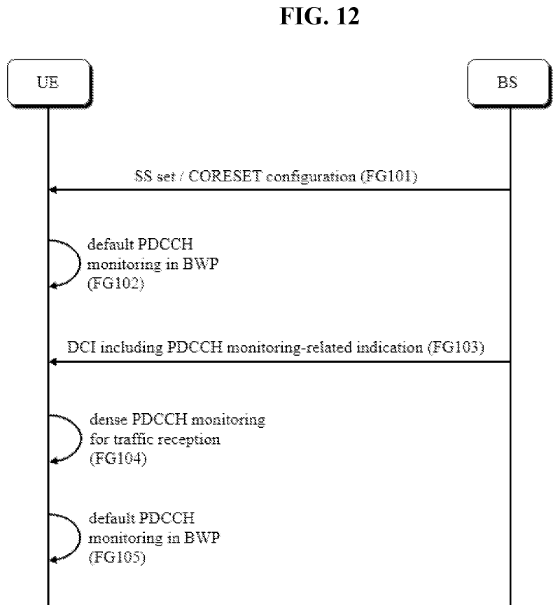

In FIG. 12, the UE may receive an NES-related configuration from a BS (1205). The NES-related configuration may include information about a DL reception operation of the UE while the NES operation is applied. For example, the NES-related configuration may include a configuration for a first mode in which the UE receives a DL signal a small number of times/in a small bandwidth while the NES operation is applied.

The UE performs DL reception in the first mode based on the NES-related configuration (1210).

The BS may transmit a signal indicating switching of the DL operation mode through DCI (1215). The signal indicating switching of the DL operation mode may be DCI. The signal indicating switching of the DL operation mode may indicate DL signal reception in a second mode, not in the first mode for applying the NES operation.

The UE performs DL reception in the second mode (1220). In the second mode, at least one of a DL signal monitoring mask and/or a DRX timer proposed in Proposal 1-1 may be used.

The UE may operate in the second mode during a configured period, and then return to the first mode and perform DL reception (1225).

FIG. 12 illustrates an example of DCI reception of a UE. FIG. 12 is an implementation example in which a DL signal is a PDCCH in Proposal 1. Specifically, it may be understood that the UE performs a smaller number of PDCCH monitoring operations by default, and upon receipt of a specific indication, increases the number of monitorings.

In FIG. 12, the UE may receive an SS set and CORESET related to PDCCH monitoring and a default operation configuration from a BS (FG101). The configuration may include a default operation of performing a smaller number of PDCCH monitorings in a BWP and monitoring occasions of SS sets related to the default operation.

The UE performs default PDCCH monitoring in a BWP based on the configuration (FG102). This may be a sparse PDCCH monitoring operation for power saving.

The BS indicates adjustment of the number of PDCCH monitorings by DCI (FG103). When this is an implicit/explicit operation due to simple DCI detection or an operation associated with a DRX timer, a direct indication in DCI from the BS may not be included.

Subsequently, the UE performs dense PDCCH monitorings through heavy traffic reception (FG104). This may be in the same manner as a PDCCH monitoring mask proposed in Proposal 1-1 or may be associated with a DRX timer.

When the dense PDCCH monitorings performed during a configured period ends, the default PDCCH monitoring is performed again sparsely in the BWP (FG105).

### [Proposal 2] Method of Reducing the Number of Detection Attempts for Specific Signal Through DCI Linkage

For example, the number of BDs may be reduced by linking different DCIs to each other. When DCI #1 and DCI #2 are linked to each other, and the UE receives DCI #1 and then expects to receive DCI #2, the UE may fully receive DCI #2 with fewer BD attempts.

### [Proposal 2-1] Paired Resource Sets (e.g., CORESETs)

Paired CORESETs may be defined to establish linkage between different DCIs. A plurality of linked CORESETs are defined as paired CORESETs. When the UE receives DCI (i.e. DCI #1) in one CORESET (i.e. CORESET #1) among the paired CORESETs, it may expect to receive linked DCI (i.e. DCI #2) in the other CORESET (i.e. CORESET #2). Since the later received linked DCI #2 is DCI that the UE already expects to receive, the UE may perform BD on DCI #2 first.

Paired CORESETs may be introduced by adding a parameter to higher layer signaling that configures CORESETs. The UE may be configured with up to four CORESETs in one BWP, and each CORESET has an index. A parameter indicating the index of a paired CORESET may be added to the configuration of a CORESET with a specific index in order to indicate which CORESET it is paired with. One CORESET may be paired with one or more CORESETs.

When the UE receives DCI #1 in an SS set linked to CORESET #1, it expects to receive DCI #2 in an SS set linked to CORESET #2 with which CORESET #1 is paired. Since a plurality of SS sets may be linked to one CORESET, an SS set or a slot in which the UE expects to receive DCI #2 may be limited. For example, the UE may expect to receive DCI #2 only in the earliest slot among the SS sets linked to CORESET #2. Alternatively, the UE may expect to receive DCI #2 during a specific number of slots from the earliest slot. This may be a time-constrained operation because the UE does not necessarily receive only linked DCI in the paired CORESET.

For DCI #2 that the UE expects to receive, the UE may prioritize the SS sets linked to CORESET #2 in a rule for calculating a maximum number of PDCCH candidates monitored per slot (or span) and the number of non-overlapped CCEs (i.e. BD/CCE dropping rule). That is, the SS sets linked to CORESET #2 are applied first before the general calculation rule of prioritizing a CSS and low SS set index. Alternatively, SS sets may be separated for a CSS and a USS, SS sets linked to CORESET #2 first in the CSS and then other SS sets in the CSS may be calculated, and then SS sets linked to CORESET #2 first in the USS may be calculated.

Information about linkage between DCIs may be indicated by a field in DCI. When a paired CORESET is configured, whether linked DCI is transmitted later in the paired CORESET may be indicated by the field in DCI. Alternatively, the SS set index of the paired CORESET may be indicated by the field.

The UE may receive DCI #1 for the purpose of XR traffic scheduling, and then use DCI #2 for the purpose of a related HARQ retransmission or reception of a PDCCH monitoring adaptation indication for power saving.

### [Proposal 2-2] Paired SS Sets

Paired SS sets may be defined to establish linkage between different DCIs. A plurality of linked SS sets are defined as paired SS sets. When the UE receives DCI (i.e. DCI #1) in an SS set (i.e. SS #1) among the paired SS sets, it may expect to receive linked DCI (i.e. DCI #2) in the other SS set. Since the later received linked DCI #2 is DCI that the UE already expects to receive, the UE may perform BD on DCI #2 first.

SS sets linked to the same CORESET may be automatically configured as paired SS sets. A CORESET with an index linked to an SS set is configured through higher layer signaling. Since up to 10 SS sets may be linked to up to 4 CORESETs, there is a high probability of linking two or more SS sets to one CORESET. The BS may configure a CORSET linked to two or more SS sets intentionally to configure paired SS sets for the UE. In the case of a configuration of paired SS sets, as the number of SS sets linked to one CORESET is small, the number of SS sets in which the UE expects to receive DCI #2 after receiving DCI #1 may be small in some cases. Accordingly, the UE may be configured with a CORESET with a specific index as a CORESET for paired SS sets, and the CORESET with the specific index may be configured to be linked to a sufficient number of SS sets. For example, CORSET index 1 may be configured as a CORESET for pairing, and the UE may identify that all SS sets linked to CORESET index 1 are paired SS sets.

When the UE receives DCI #1 in SS #1, it expects to receive DCI #2 in one or more paired SS sets. Since a plurality of SS sets may be linked, an SS set or a slot in which the UE expects to receive DCI #2 may be limited. For example, the UE may expect to receive DCI #2 only in the earliest slot among the paired SS sets. Alternatively, the UE may expect to receive DCI #2 during a specific number of slots from the earliest slot. This may be a time-constrained operation because the UE does not necessarily receive only linked DCI in the paired CORESET.

For DCI #2 that the UE expects to receive, the UE may prioritize paired SS sets in a rule for calculating a maximum number of PDCCH candidates monitored per slot (or span) and the number of non-overlapped CCEs (i.e. BD/CCE dropping rule). That is, the paired SS sets are applied first before the general calculation rule of prioritizing a CSS and low SS set index. Alternatively, SS sets may be separated for a CSS and a USS, paired SS sets first in the CSS and then other SS sets in the CSS may be calculated, and then paired SS sets in the USS may be calculated.

Information about linkage between DCIs may be indicated by a field in DCI. When a paired SS set is configured, whether linked DCI is transmitted later in the paired SS set may be indicated by the field in DCI. Alternatively, the SS set index of the paired SS set may be indicated by the field.

The UE may receive DCI #1 for the purpose of XR traffic scheduling, and then use DCI #2 for the purpose of a related HARQ retransmission or reception of a PDCCH monitoring adaptation indication for power saving.

### [Proposal 2-3] Additional Configuration for Reducing the Number of Detection Attempts

A better power saving effect may be expected through an additional configuration for DCI linkage proposed in Proposal 2-1 and Proposal 2-2.

The same aggregation level (AL) may be configured for linked DCIs. The UE may reduce the number of BDs by attempting BD only for an AL at which the UE has succeeded BD of DCI #1. When the AL of the successfully decoded DCI #1 exceeds an AL that may be configured for an SS set in which the UE may expect to receive DCI #2, the UE may consider that there is no reception of the linked DCI in the SS set.

Alternatively, the AL of DCI #2 that the UE expects to receive may always be set to be less than or equal to the AL of the previously received DCI #1. This may be for the purpose of reducing the total number of BD attempts by allowing the UE to perform BD for only some ALs rather than all ALs. In addition, this may be based on the purpose served by the linked DCI, such as DCI #1 as scheduling DCI and DCI #2 as non-scheduling DCI (or DCI for other purposes).

An AL may be determined based on a channel state information (CSI) report including a UL transmission of channel quality information (CQI) from the UE. The BS may obtain information about multiple channels based on the CSI report of the UE, and adjust an AL for linked DCI based on the information. For example, when the channel condition is not good, DCI #2 may be transmitted at a high AL for a retransmission procedure.

An AL may be configured in association with SS set group (SSSG) switching, which is one of PDCCH monitoring adaptations. For example, when SS sets where MOs are frequently located are configured as an SSSG for traffic reception, the UE may perform BD, expecting a fixed AL for this dense monitoring. This may be done to allow the UE to perform BD only for some fixed ALs rather than for all ALs in order to reduce a large number of BDs that the UE should perform during dense monitoring.

The method has been proposed in which a UE performs PDCCH monitoring a small number of times by default, and upon receipt of a specific indication, increases the number of monitorings. In this case, the UE may perform PDCCH monitoring sparsely until before receiving the specific indication, thereby expecting the power saving effect, and reliably receive heavy traffic by additionally increasing the number of monitorings according to the specific indication. Further, the method of reducing the number of BDs by DCI linkage has been described. In a multi-DCI linked configuration, upon receipt of one DCI, the UE may expect to receive its linked DCI and receive the linked DCI reliably by fewer BDs.

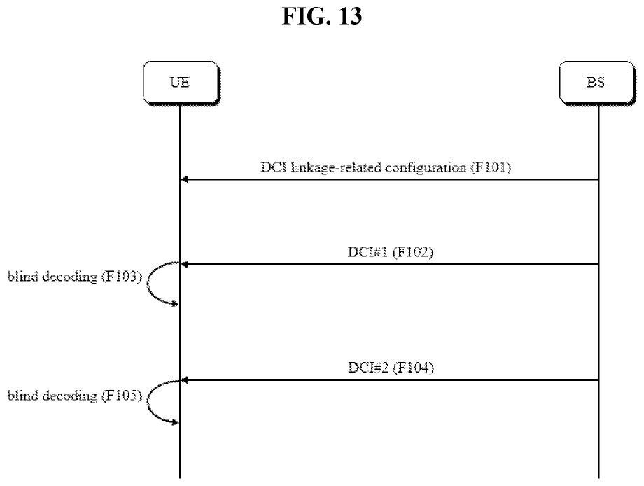

FIG. 13 illustrates an example of DCI reception of a UE. FIG. 13 may be understood as an implementation example of applying Proposal 2.

Referring to FIG. 13, the UE may receive a DCI linkage-related configuration from a BS (F101). This may be done to reduce the number of BDs for received DCI by linking different DCIs to each other. In this regard, configurations such as paired CORESETs (Proposal 2-1) and paired SS sets (Proposal 2-2) may be included.

The BS transmits DCI #1 through an SS set with a linkage configuration (F102).

The UE performs BD for DCI #1 by applying a general BD/CCE mapping rule (F103). The BS transmits DCI #2 (F104).

After successfully decoding DCI #1, the UE monitors DCI #2 linked to the corresponding DCI during a specific slot or a specific period (F105). DCI #2 may be received through an SS set having a linkage configuration, and the UE may successfully receive the corresponding DCI with a smaller number of BDs by applying the BD/CCE mapping rule based on this.

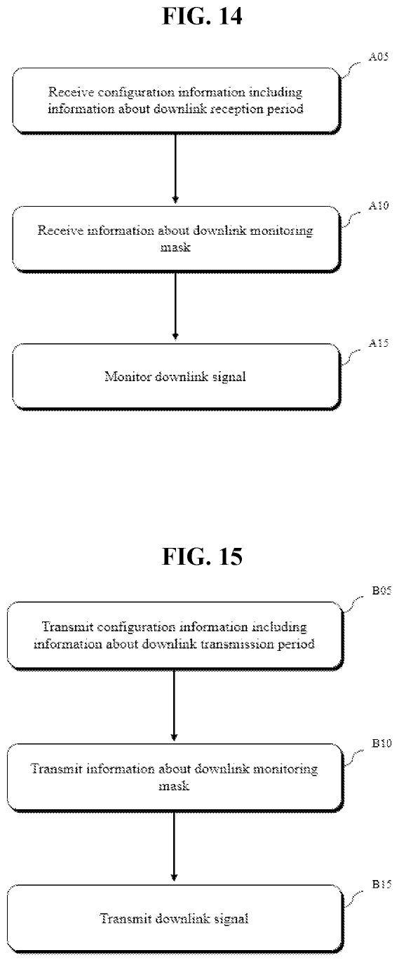

FIG. 14 is a diagram illustrating signal reception of a UE according to an embodiment.

Referring to FIG. 14, the UE may receive configuration information including information about a downlink reception periodicity through higher layer signaling (A05).

The UE may receive information about a downlink monitoring mask for controlling the downlink reception periodicity through lower layer signaling (A10).

The UE may monitor a downlink signal based on the downlink reception periodicity and the downlink monitoring mask (A15).

The downlink signal may be monitored based on an integer multiple of the downlink reception periodicity during a first time period to which the downlink monitoring mask is not applied. The downlink signal may be monitored based on the downlink reception periodicity during a second time period to which the downlink monitoring mask is applied.

The downlink signal may include a PDCCH. The configuration information may include configuration information about a search space set for PDCCH candidates.

The information about the downlink monitoring mask may be received through DCI.

The downlink signal may be monitored only in some of downlink resource configurations provided to the UE during the first time period to which the downlink monitoring mask is not applied.

The downlink signal may be monitored in all of the downlink resource configurations provided to the UE during the second time period to which the downlink monitoring mask is not applied.

The first time period and the second time period may be determined based on a timer.

The timer may be a DRX-related timer.

The information about the downlink monitoring mask may activate a first downlink monitoring mask among a plurality of downlink monitoring masks configured for the UE.

The higher layer signaling may be RRC signaling, and the lower layer signaling may be MAC signaling or PHY signaling.

FIG. 15 is a diagram illustrating signal transmission of a BS according to an embodiment.

Referring to FIG. 15, the BS may transmit configuration information including information about a downlink transmission period through higher layer signaling (B05).

The BS may transmit information about a downlink monitoring mask for controlling the downlink transmission period through lower layer signaling (B10).

The BS may transmit a downlink signal based on the downlink transmission period and the downlink monitoring mask (B15). The downlink signal may be transmitted based on an integer multiple of the downlink transmission period during a first time period to which the downlink monitoring mask is not applied. The downlink signal may be transmitted based on the downlink transmission period during a second time period to which the downlink monitoring mask is applied.

The downlink signal may include a PDCCH. The configuration information may include configuration information about a search space set for PDCCH candidates.

The information about the downlink monitoring mask may be transmitted through DCI.

The downlink signal may be monitored only in some of downlink resource configurations configured for a UE by the VS during the first time period to which the downlink monitoring mask is not applied.

The downlink signal may be monitored in all of the downlink resource configurations configured for the UE by the BS during the second time period to which the downlink monitoring mask is not applied.

The first time period and the second time period may be determined based on a timer. The timer may be a DRX-related timer.

The information about the downlink monitoring mask may activate a first downlink monitoring mask among a plurality of downlink monitoring masks configured for the UE by the BS.

The higher layer signaling may be RRC signaling, and the lower layer signaling may be MAC signaling or PHY signaling.

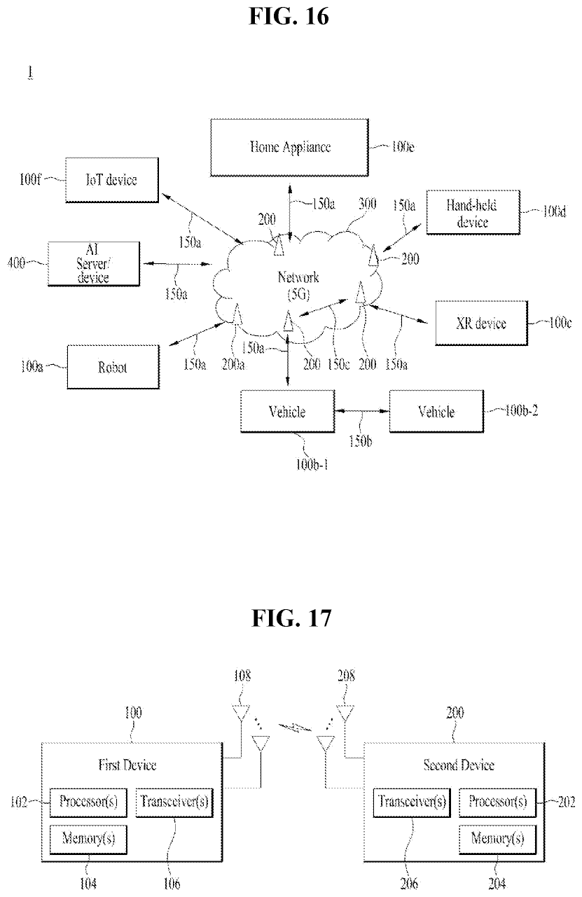

FIG. 16 illustrates a communication system 1 applied to the present disclosure.

Referring to FIG. 16, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 17 illustrates wireless devices applicable to the present disclosure.

Referring to FIG. 17, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In an embodiment of the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In an embodiment of the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

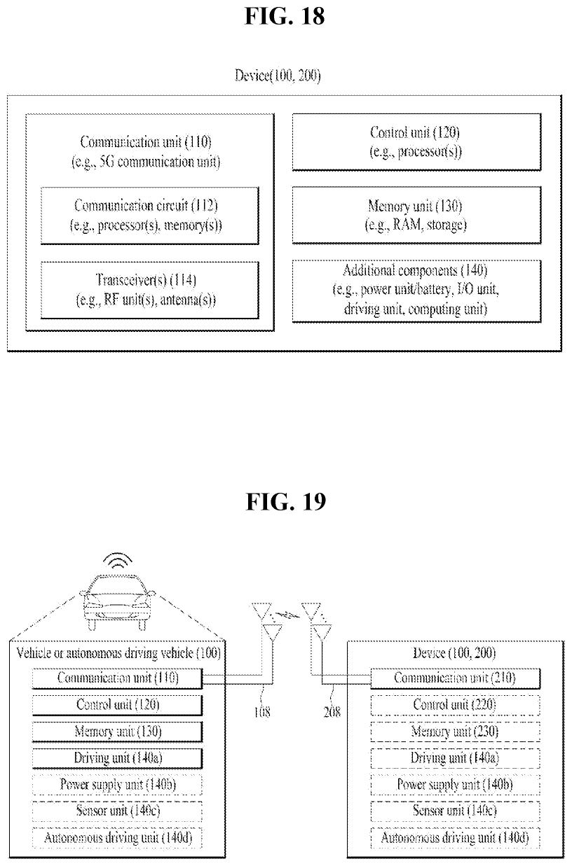

FIG. 18 illustrates another example of a wireless device applied to the present disclosure. The wireless device may be implemented in various forms according to a use-case/service (refer to FIG. 16).

Referring to FIG. 18, wireless devices 100 and 200 may correspond to the wireless devices 100 and 200 of FIG. 17 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 17. For example, the transceiver(s) 114 may include the one or more transceivers 106 and 206 and/or the one or more antennas 108 and 208 of FIG. 17. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 16), the vehicles (100b-1 and 100b-2 of FIG. 16), the XR device (100c of FIG. 16), the hand-held device (100d of FIG. 16), the home appliance (100e of FIG. 16), the IoT device (100f of FIG. 16), a digital broadcast terminal, a hologram device, a public safety device, an MTC device, a medicine device, a fintech device (or a finance device), a security device, a climate/environment device, the AI server/device (400 of FIG. 16), the BSs (200 of FIG. 16), a network node, etc. The wireless device may be used in a mobile or fixed place according to a use-example/service.

In FIG. 18, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

FIG. 19 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 19, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 18, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The above-described embodiments correspond to combinations of elements and features of the present disclosure in prescribed forms. And, the respective elements or features may be considered as selective unless they are explicitly mentioned. Each of the elements or features can be implemented in a form failing to be combined with other elements or features. Moreover, it is able to implement an embodiment of the present disclosure by combining elements and/or features together in part. A sequence of operations explained for each embodiment of the present disclosure can be modified. Some configurations or features of one embodiment can be included in another embodiment or can be substituted for corresponding configurations or features of another embodiment. And, an embodiment may be configured by combining claims failing to have relation of explicit citation in the appended claims together or can be included as new claims by amendment after filing an application.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure is applicable to UEs, BSs, or other apparatuses in a wireless mobile communication system.

1. A method performed by a user equipment (UE), the method comprising:
receiving, through higher layer signaling, configuration information including information about a downlink reception periodicity;
receiving, through lower layer signaling, information about a downlink monitoring mask for adjusting the downlink reception periodicity; and
monitoring a downlink signal based on the downlink reception periodicity and the downlink monitoring mask,
wherein the downlink signal is monitored based on an integer multiple of the downlink reception periodicity during a first time period in which the downlink monitoring mask is not applied, and
wherein the downlink signal is monitored based on the downlink reception periodicity during a second time period in which the downlink monitoring mask is applied.

2. The method of claim 1, wherein the downlink signal includes a physical downlink control channel (PDCCH), and
wherein the configuration information includes configuration information about a search space set for PDCCH candidates.

3. The method of claim 1, wherein the information about the downlink monitoring mask is received through downlink control information (DCI).

4. The method of claim 1, wherein the downlink signal is monitored only in some of downlink resource configurations provided to the UE during the first time period in which the downlink monitoring mask is not applied, and
wherein the downlink signal is monitored in all of the downlink resource configurations provided to the UE during the second time period in which the downlink monitoring mask is applied.

5. The method of claim 1, wherein the first time period and the second time period are determined based on a timer.

6. The method of claim 1, wherein the timer is a discontinuous reception (DRX)-related timer.

7. The method of claim 1, wherein the information about the downlink monitoring mask activates a first downlink monitoring mask among a plurality of downlink monitoring masks configured for the UE.

8. The method of claim 1, wherein the higher layer signaling is radio resource control (RRC) signaling, and the lower layer signaling is medium access control (MAC) signaling or physical layer (PHY) signaling.

9. A non-transitory computer-readable recording medium having recorded thereon a program for performing the method of claim 1.

10. A device comprising:
a memory configured to store instructions; and
a processor configured to perform operations by executing the instructions,
wherein the operations of the processor include:
receiving, through higher layer signaling, configuration information including information about a downlink reception periodicity;
receiving, through lower layer signaling, information about a downlink monitoring mask for adjusting the downlink reception periodicity; and
monitoring a downlink signal based on the downlink reception periodicity and the downlink monitoring mask,
wherein the downlink signal is monitored based on an integer multiple of the downlink reception periodicity during a first time period in which the downlink monitoring mask is not applied, and
wherein the downlink signal is monitored based on the downlink reception periodicity during a second time period in which the downlink monitoring mask is applied.

11. The device of claim 10, further comprising:
a transceiver transmitting or receiving a wireless signal under control of the processor,
wherein the device is a user equipment (UE) operating in a wireless communication system.

12. The device of claim 10, wherein the device is a signal processing device configured to control a user equipment (UE) operating in a wireless communication system.

13. A method performed by a base station (BS), the method comprising:
transmitting, through higher layer signaling, configuration information including information about a downlink transmission period;
transmitting, through lower layer signaling, information about a downlink monitoring mask for adjusting the downlink transmission period; and
transmitting a downlink signal based on the downlink transmission period and the downlink monitoring mask,
wherein the downlink signal is transmitted based on an integer multiple of the downlink transmission period during a first time period in which the downlink monitoring mask is not applied, and
wherein the downlink signal is transmitted based on the downlink transmission period during a second time period in which the downlink monitoring mask is applied.

14. (canceled)
